(19) United States
(12) Patent Application Publication
(10) Pub. No.: US 2019/0050028 A1
(43) Pub. Date: Feb. 14, 2019

(54) HINGE STRUCTURE, ELECTRONIC DEVICE AND ASSEMBLING METHOD OF HINGE STRUCTURE

(71) Applicants: Ming-Hung Chung, Taipei City (TW); You-Yu Chen, Taipei City (TW); Chia-Huang Chan, Taipei City (TW)

(72) Inventors: Ming-Hung Chung, Taipei City (TW); You-Yu Chen, Taipei City (TW); Chia-Huang Chan, Taipei City (TW)

(73) Assignee: COMPAL ELECTRONICS, INC., Taipei City (TW)

(21) Appl. No.: 15/905,825

(22) Filed: Feb. 27, 2018

Related U.S. Application Data
(60) Provisional application No. 62/544,889, filed on Aug. 13, 2017.

(51) Int. Cl. G06F 1/16; F16C 11/04; E05D 3/12; E05D 11/00

(52) U.S. Cl. CPC G06F 1/1681; F16C 11/04; E05D 3/122; F16C 11/103; E05Y 2600/50; E05Y 2900/606; E05D 11/0054; E05D 11/0081

(57) ABSTRACT

A hinge structure includes a pivot bracket, a first shaft, a second shaft, and a cable. The first shaft is pivoted to the pivot bracket and has a first through hole. The second shaft is pivoted to the pivot bracket and has a second through hole. The cable includes a first penetrating segment, a second penetrating segment, and a curved segment. The first penetrating segment penetrates through the first through hole, the second penetrating segment penetrates through the second through hole, and two ends of the curved segment are respectively connected to the first penetrating segment and the second penetrating segment. In addition, an electronic device including the hinge structure and an assembling method of the hinge structure are also provided.

### CROSS-REFERENCE TO RELATED APPLICATION

This application claims the priority benefits of U.S. provisional application Ser. No. 62/544,889, filed on Aug. 13, 2017. The entirety of the above-mentioned patent application is hereby incorporated by reference herein and made a part of this specification.

### BACKGROUND OF THE INVENTION

### 1. Field of the Invention

The invention relates to a hinge structure, an electronic device, and an assembling method of the hinge structure. More particularly, the invention relates to a hinge structure having dual shafts, an electronic device including the hinge structure, and an assembling method of the hinge structure.

### 2. Description of Related Art

A notebook computer is generally composed of a host and a display. In order to allow the notebook computers to be operated and used in diverse manners to satisfy users' needs, the displays of some notebook computers can be flipped over to the rear sides of the hosts, so that the notebook computers can be used as tablet computers. Accordingly, the hinge structures of some of the notebook computers are designed to have dual shafts. As such, the notebook computers can be pivoted at large angles by the users through the dual shafts, and that the displays of the notebook computers may be flipped over to the rear sides of the hosts. In another aspect, a cable connected between the host and the display is required to be designed to pass through the hinge structure. When the hinge structure is designed to have the dual shafts as described above and is configured for large-angle pivoting, how the cable can be designed to occupy less allocation space in the hinge structure and to be prevented from being excessively twisted as affected by large-angle pivoting is an important issue in the design of the hinge structure.

### SUMMARY OF THE INVENTION

The invention provides a hinge structure in which an allocation space is saved and a cable passing through the hinge structure is prevented from being excessively twisted along with pivoting of the hinge structure.

In an embodiment of the invention, a hinge structure includes a pivot bracket, a first shaft, a second shaft, and a cable. The first shaft is pivoted to the pivot bracket and has a first through hole. The second shaft is pivoted to the pivot bracket and has a second through hole. The cable includes a first penetrating segment, a second penetrating segment, and a curved segment. The first penetrating segment penetrates through the first through hole, the second penetrating segment penetrates through the second through hole, and two ends of the curved segment are respectively connected to the first penetrating segment and the second penetrating segment.

The invention also provides an electronic device including a host, a display, and a hinge structure. The hinge structure includes a pivot bracket, a first shaft, a second shaft, and a cable. The first shaft is pivoted to the pivot bracket and has a first through hole, and the first shaft is connected to the host. The second shaft is pivoted to the pivot bracket and has a second through hole, and the second shaft is connected to the display. The cable includes a first penetrating segment, a second penetrating segment, and a curved segment. The first penetrating segment penetrates through the first through hole, the second penetrating segment penetrates through the second through hole, and two ends of the curved segment are respectively connected to the first penetrating segment and the second penetrating segment.

In an embodiment of the invention, the first shaft is pivoted to the pivot bracket along a first axis, the second shaft is pivoted to the pivot bracket along a second axis, and the first axis is parallel to the second axis.

In an embodiment of the invention, the first through hole extends along the first axis, and the second through hole extends along the second axis.

In an embodiment of the invention, the hinge structure includes a first holder and a second holder. The first holder is connected to the first shaft, and the first shaft is connected to the host through the first holder. The second holder is connected to the second shaft, and the second shaft is connected to the display through the second holder.

In an embodiment of the invention, the pivot bracket is located between the first holder and the curved segment and is located between the second holder and the curved segment.

In an embodiment of the invention, the first shaft has a first groove, and the second shaft 130b has a second groove. The first groove is located between the first holder and the first through hole, and the second groove is located between the second holder and the second through hole. The first penetrating segment extends to the first groove and curves in the first groove to extend to an outside of the first shaft, and the second penetrating segment extends to the second groove and curves in the second groove to extend to an outside of the second shaft.

In an embodiment of the invention, the first groove has a first arc-shaped surface inside, and the second groove has a second arc-shaped surface inside.

In an embodiment of the invention, the hinge structure includes an elastic tube. The elastic tube has a first opening and a second opening opposite to each other. The first opening and the second opening are respectively connected to the first through hole and the second through hole. The curved segment is located in the elastic tube.

In an embodiment of the invention, the hinge structure includes another cable. The elastic tube has a third opening. The another cable penetrates through the first through hole and passes through the first opening and the third opening.

The invention further provides an assembling method of a hinge structure which includes following steps. A first shaft is pivoted to a pivot bracket. A second shaft is pivoted to the pivot bracket. A cable is provided to penetrate through a first through hole of the first shaft. The cable penetrating out through the first through hole is curved. The curved cable is provided to penetrate through a second through hole of the second shaft.

In an embodiment of the invention, the assembling method of the hinge structure includes following steps. Two ends of an elastic tube are respectively connected to the first through hole and the second through hole. The cable penetrating out through the first through hole is provided to penetrate through the elastic tube to reach the second through hole.

To sum up, in the hinge structure provided by the embodiments of the invention, the first shaft and the second shaft both have the through holes and thus are hollow shafts. The cable passing through the hinge structure may thereby penetrate through the first shaft and the second shaft. As such, the cable does not excessively occupy the allocation space outside the first shaft and the second shaft. In addition, the cable penetrates through the first shaft and the second shaft and extends respectively along the rotating axes. Therefore, when the first shaft and the second shaft are pivoted, considerable shifting of the cable winding around the rotating axes is not generated, and the cable is thus prevented from being excessively twisted along with pivoting of the first shaft and the second shaft.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a three-dimensional view of an electronic device according to an embodiment of the invention.

FIG. 2 is a three-dimensional view of the pivot assembly of FIG. 1.

FIG. 3 is a three-dimensional view of part of components of the hinge structure of FIG. 2.

FIG. 4 is a three-dimensional view of part of the components of the hinge structure of FIG. 3.

FIG. 5 is a three-dimensional view of a cable and an elastic tube of FIG. 3.

FIG. 6 is a local schematic view of the first shaft in the first groove of FIG. 3.

FIG. 7 is an exploded view of part of the components of the hinge structure of FIG. 3.

FIG. 8 is a flowchart of an assembling method of a hinge structure according to an embodiment of the invention.

FIG. 9A to FIG. 9H illustrate the assembling process of the hinge structure of FIG. 3.

FIG. 10 is a three-dimensional view of a pivot assembly according to another embodiment of the invention.

FIG. 11 is a three-dimensional view of part of components of a hinge structure of FIG. 10.

FIG. 12 is a three-dimensional view of part of components of the pivot assembly of FIG. 10.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

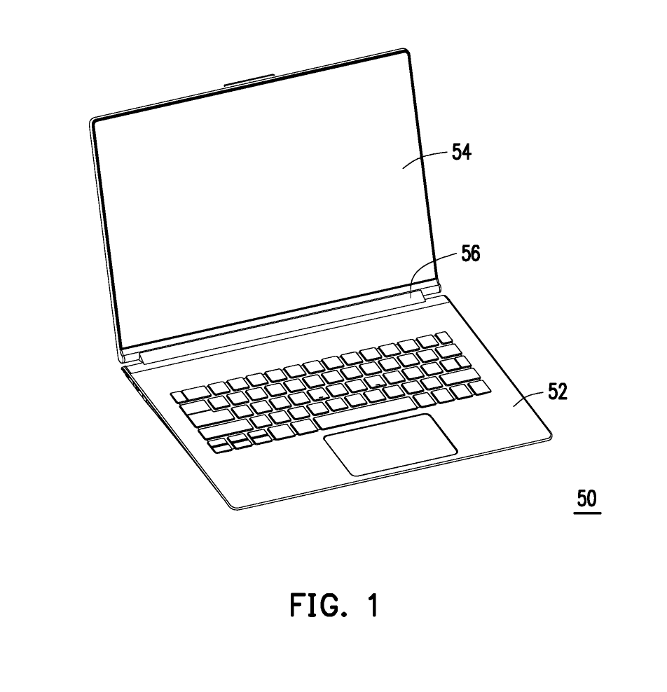

FIG. 1 is a three-dimensional view of an electronic device according to an embodiment of the invention. With reference to FIG. 1, an electronic device 50 of this embodiment is, for example, a notebook computer and includes a host 52, a display 54, and a pivot assembly 56. The host 52 and the display 54 are pivoted to each other through the pivot assembly 56.

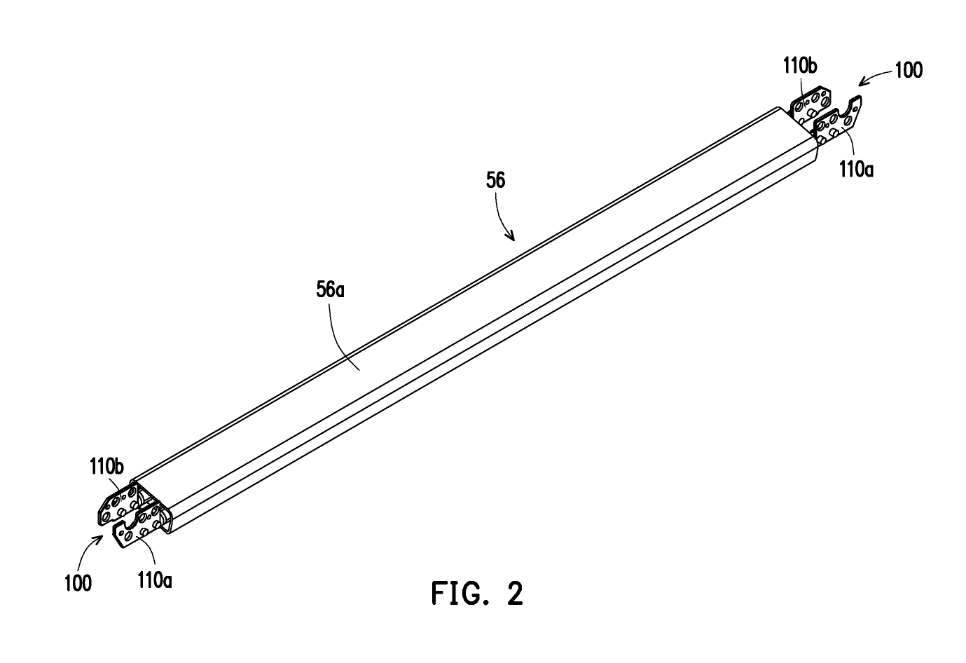

FIG. 2 is a three-dimensional view of the pivot assembly of FIG. 1. With reference to FIG. 2, the pivot assembly 56 includes a housing 56a and two hinge structures 100. The housing 56a covers a portion of a structure of each of the hinge structures 100. A first holder 110a and a second holder 110b of each of the hinge structures 100 are respectively configured to connect the host 52 and the display 54.

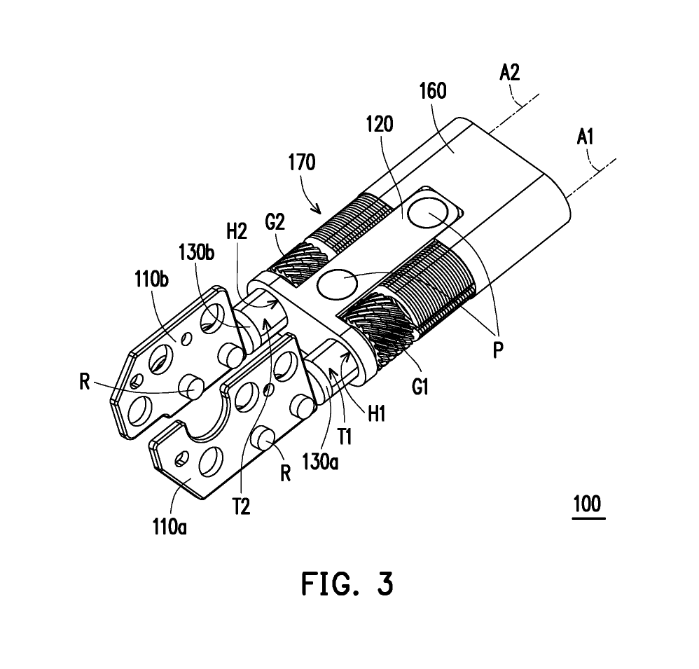

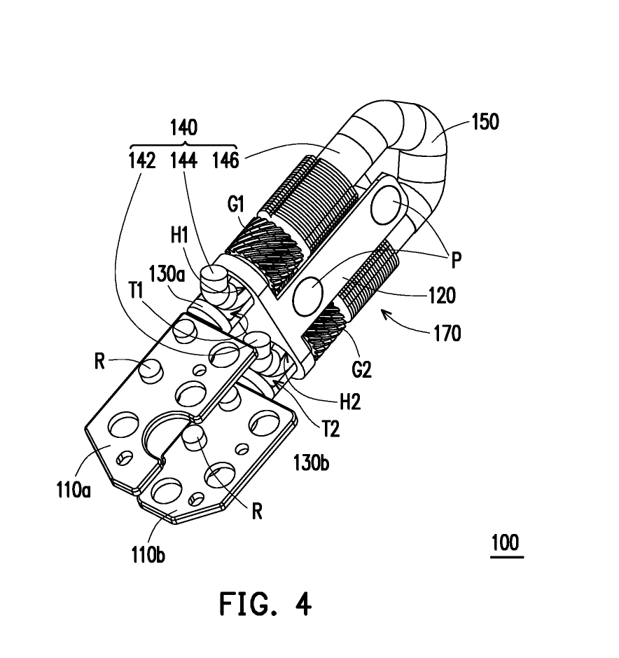

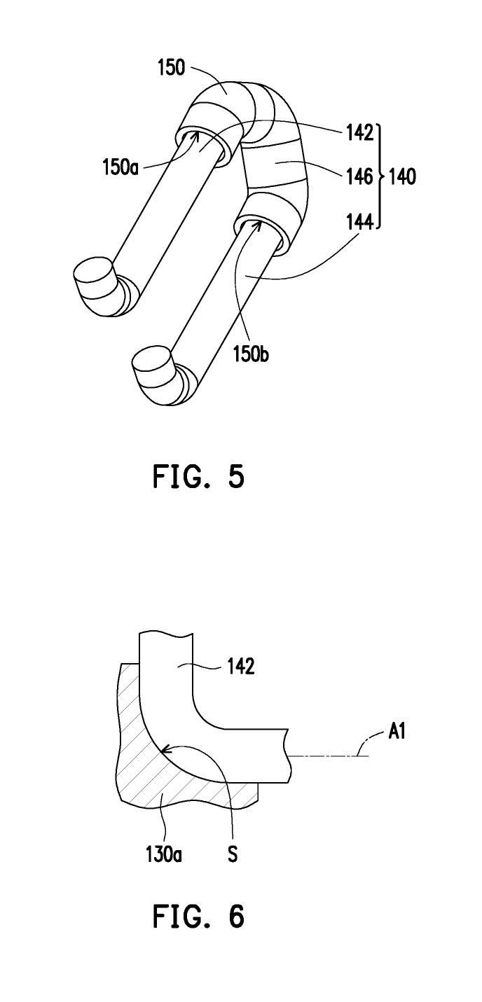

FIG. 3 is a three-dimensional view of part of components of the hinge structure of FIG. 2. FIG. 4 is a three-dimensional view of part of the components of the hinge structure of FIG. 3. FIG. 5 is a three-dimensional view of a cable and an elastic tube of FIG. 3. In order to have a clearer figure, a cable 140 is not illustrated in FIG. 3, and a fixing cover 160 is not illustrated in FIG. 4. With reference to FIG. 3 to FIG. 5, the hinge structure 100 includes a pivot bracket 120, a first shaft 130a, a second shaft 130b, and the cable 140. The first shaft 130a is pivoted to the pivot bracket 120 along a first axis A1 and has a first through hole H1 extending along the first axis A1. The second shaft 130b is pivoted to the pivot bracket 120 along a second axis A2 parallel to the first axis A1 and has a second through hole H2 extending along the second axis A2. The first holder 110a and the second holder 110b are respectively connected to the first shaft 130a and the second shaft 130b. The first shaft 130a is connected to the host 52 (illustrated in FIG. 1) through the first holder 110a. The second shaft 130b is connected to the display 54 (illustrated in FIG. 1) through the second holder 110b.

The cable 140 includes a first penetrating segment 142, a second penetrating segment 144, and a curved segment 146. The first penetrating segment 142 penetrates through the first through hole H1 of the first shaft 130a, and the second penetrating segment 144 penetrates through the second through hole H2 of the second shaft 130b. Two ends of the curved segment 146 are respectively connected to the first penetrating segment 142 and the second penetrating segment 144. The first penetrating segment 142 and the second penetrating segment 144 are respectively connected to the host 52 (illustrated in FIG. 1) end and the display 54 (illustrated in FIG. 1) end. The pivot bracket 120 is located between the first holder 110a and the curved segment 146 and is located between the second holder 110b and the curved segment 146.

As described above, the first shaft 130a and the second shaft 130b respectively have the first through hole H1 and the second through hole H2; thus, the first shaft 130a and the second shaft 130b are hollow shafts. The cable 140 passing through the hinge structure 100 may thereby penetrate through the first shaft 130a and the second shaft 130b. As such, the cable 140 does not excessively occupy an allocation space outside the first shaft 130a and the second shaft 130b. Besides, the cable 140 penetrates through the first shaft 130a and the second shaft 130b and extends respectively along the first axis A1 and the second axis A2. As such, when the first shaft 130a and the second shaft 130b are pivoted, considerable shifting of the cable 140 winding around the first axis A1 and the second axis A2 is not generated, and the cable 140 is thus prevented from being excessively twisted along with pivoting of the first shaft 130a and the second shaft 130b.

In addition, the hinge structure 100 of this embodiment includes an elastic tube 150 and a fixing cover 160. The elastic tube 150 is, for example, a rubber tube body and has first opening 150a and a second opening 150b opposite to each other. The first opening 150a and the second opening 150b are respectively connected to the first through hole H1 of the first shaft 130a and the second through hole H2 of the second shaft 130b. The curved segment 146 of the cable 140 is located in the elastic tube 150, and the fixing cover 160 covers the elastic tube 150. As the elastic tube 150 is elastic, the cable 140 is thereby prevented from being disposed in an excessively tight state. In addition, the cable 140 is covered by the elastic tube 150 and the fixing cover 160, and thus, the cable 140 is prevented from being unexpectedly wound around other components in an assembling process.

In this embodiment, the first shaft 130a has a first groove T1, and the second shaft 130b has a second groove T2. The first groove T1 is located between the first holder 110a and the first through hole H1, and the second groove T2 is located between the second holder 110b and the second through hole H2. The first penetrating segment 142 of the cable 140 extends to the first groove T1 and curves in the first groove T1 to extend to an outside of the first shaft 130a, and the second penetrating segment 144 of the cable 140 extends to the second groove T2 and curves in the second groove T2 to extend to an outside the second shaft 130b. FIG. 6 is a local schematic view of the first shaft in the first groove of FIG. 3. With reference to FIG. 6, the first groove T1 (shown in FIG. 3 and FIG. 4) of this embodiment has a first arc-shaped surface S inside, and the first penetrating segment 142 of the cable 140 may bend along with the first arc-shaped surface S. Similarly, the second groove T1 (shown in FIG. 3 and FIG. 4) of this embodiment has a second arc-shaped surface inside, and the second penetrating segment 144 of the cable 140 may bend along with the second arc-shaped surface. Since the second arc-shaped surface in the second groove T2 is similar to the first arc-shaped surface S in the first groove T1, the second arc-shaped surface is not additionally illustrated herein.

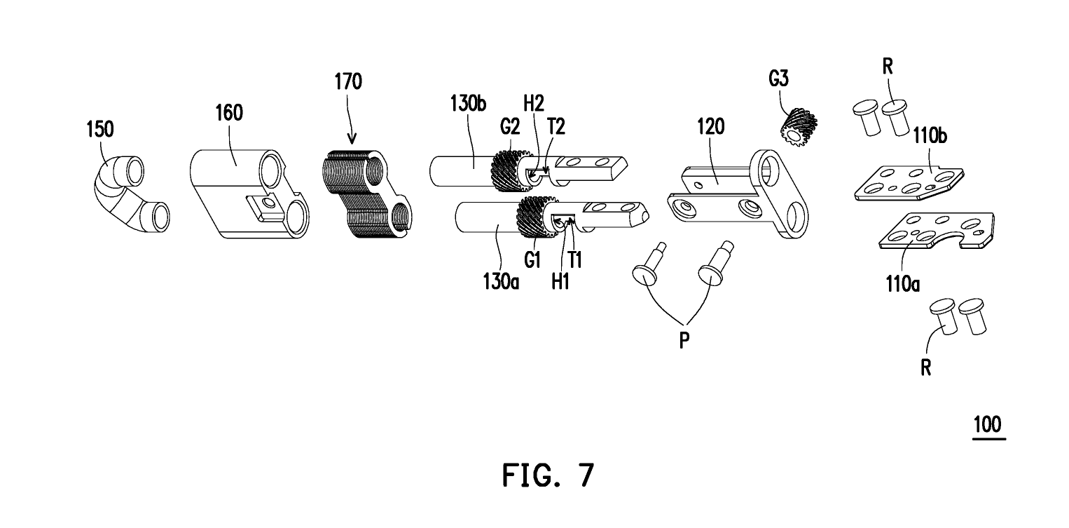

The rest of the structure of the hinge structure 100 is described as follows. FIG. 7 is an exploded view of part of the components of the hinge structure of FIG. 3. With reference to FIG. 3, FIG. 4, and FIG. 7, the first shaft 130a has a first gear G1, and the second shaft 130b has a second gear G2. An idle wheel G3 is engaged between the first gear G1 and the second gear G2. It thus can be seen that the first shaft 130a and the second shaft 130b are linked up and are pivoted to each other in opposite directions through the first gear G1, the second gear G2, and the idle wheel G3. Besides, a torsion spring set 170 is sleeved on the first shaft 130a and the second shaft 130b and is fixed by the fixing cover 160 for providing a torsion force required by the hinge structure 100. Moreover, the first holder 110a and the second holder 110b are respectively assembled to the first shaft 130a and the second shaft 130b through rivets R, and the fixing cover 160 and the idle wheel G3 are assembled to the pivot bracket 120 through pins P.

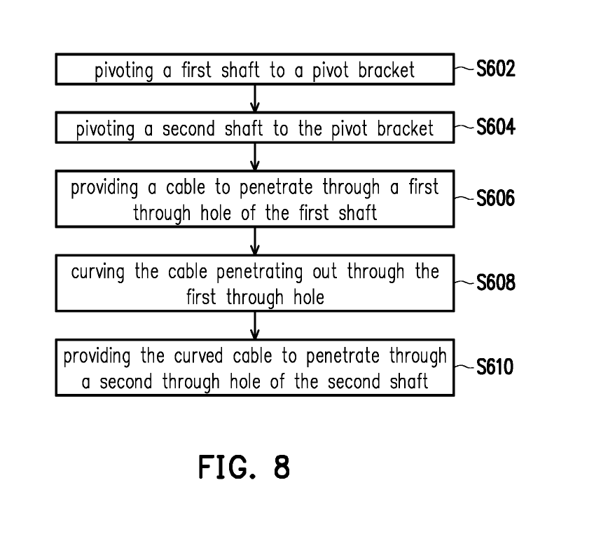

FIG. 8 is a flowchart of an assembling method of a hinge structure according to an embodiment of the invention. With reference to FIG. 8, a first shaft is pivoted to a pivot bracket (step S602). A second shaft is pivoted to the pivot bracket (step S604). A cable is provided to penetrate through a first through hole of the first shaft (step S606). The cable penetrating out through the first through hole is curved (step S608). The curved cable is provided to penetrate through a second through hole of the second shaft (step S610).

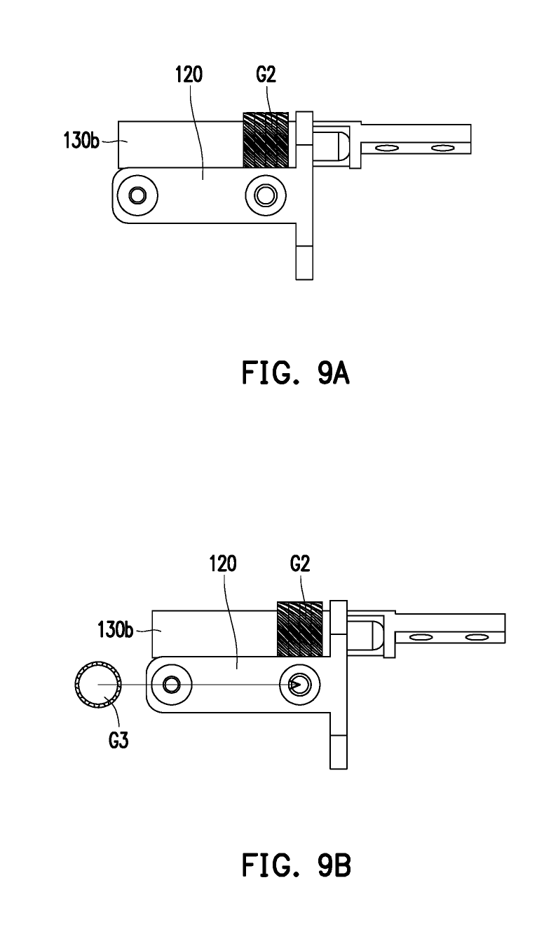

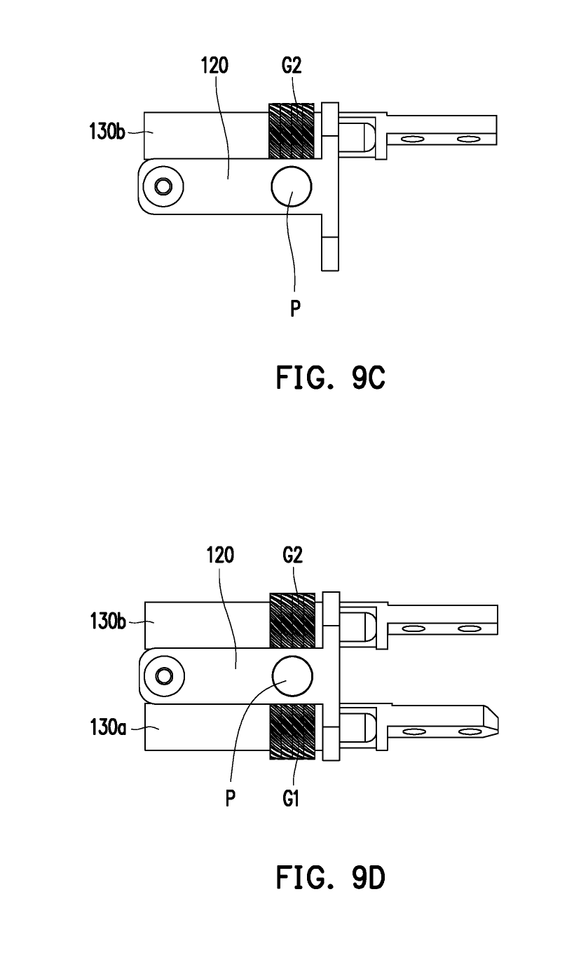

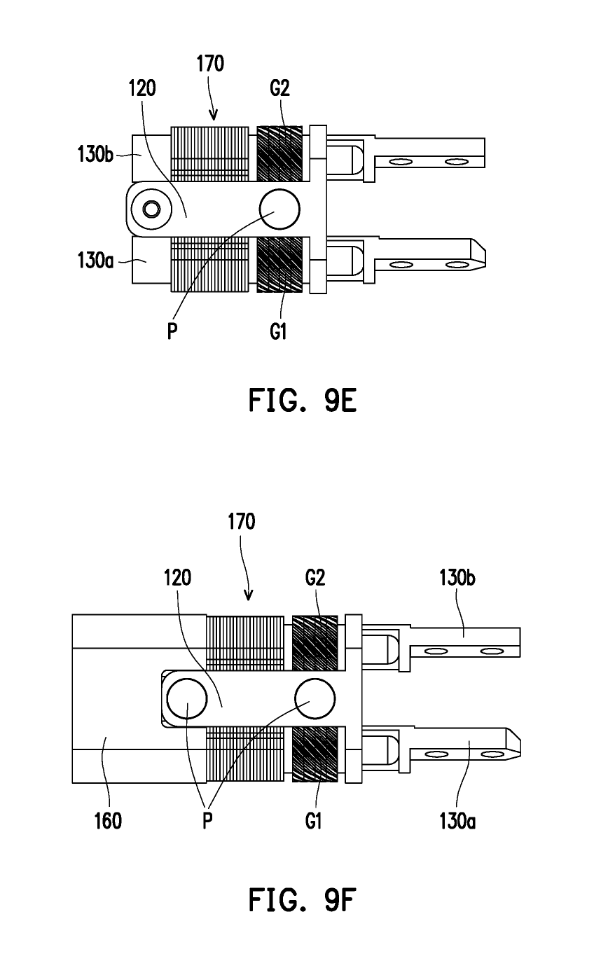

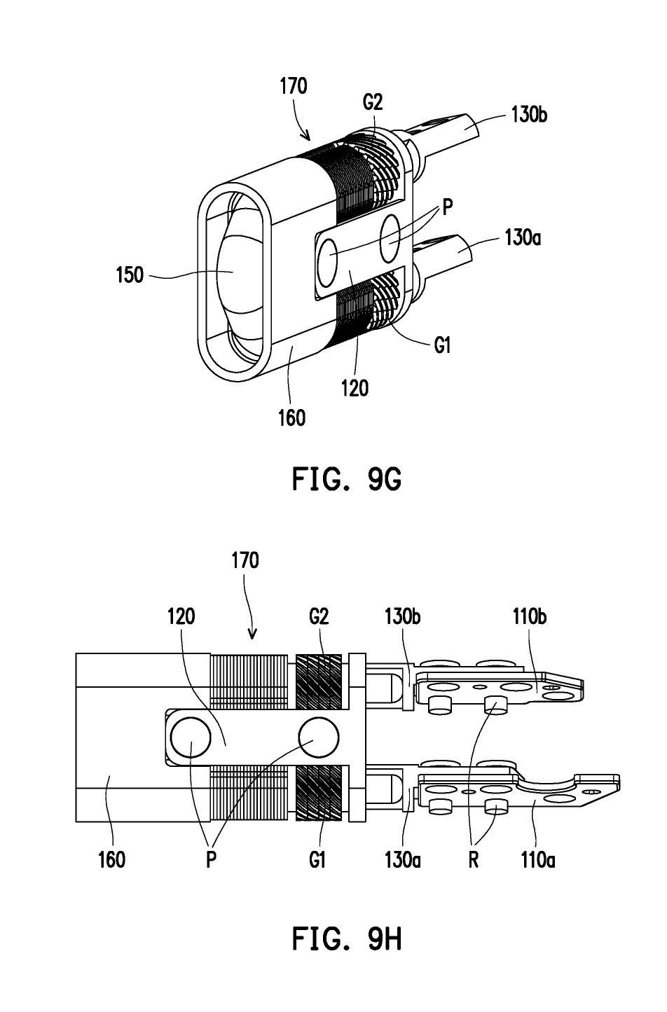

The hinge structure 100 shown in FIG. 3 to FIG. 7 is taken as an example, and an assembling process of the hinge structure is described in detail as follows. FIG. 9A to FIG. 9H illustrate the assembling process of the hinge structure of FIG. 3. First, the second shaft 130b is pivoted to the pivot bracket 120 as shown in FIG. 9A. Next, the idle wheel G3 is moved into the pivot bracket 120 as shown by the arrow in FIG. 9B. The idle wheel G3 (illustrated in FIG. 9B) is assembled to the pivot bracket 120 through the pin P as shown in FIG. 9C. As shown in FIG. 9D, the first shaft 130a is pivoted to the pivot bracket 120, and at this time, the idle wheel G3 is engaged between the first gear G1 of the first shaft 130a and the second gear G2 of the second shaft 130b. As shown in FIG. 9E, the torsion spring set 170 is sleeved on the first shaft 130a and the second shaft 130b. As shown in FIG. 9F, the fixing cover 160 is mounted to the pivot bracket 120 to fix the torsion spring set 170, and the fixing cover 160 is fixed to the pivot bracket 120 through the other pin P. As shown in FIG. 9G, the elastic tube 150 is mounted into the fixing cover 160, two ends of the elastic tube 150 are thereby respectively connected to the first through hole H1 (shown in FIG. 3 and FIG. 4) of the first shaft 130a and the second through hole H2 (shown in FIG. 3 and FIG. 4) of the second shaft 130b. As shown in FIG. 9H, the first holder 110a and the second holder 110b are respectively assembled to the first shaft 130a and the second shaft 130b through the rivets R. Finally, the cable 140 is inserted in the first shaft 130a, the elastic tube 150, and the second shaft 130b as shown in FIG. 4. For instance, the cable 140 penetrating out through the first through hole H1 (shown in FIG. 3 and FIG. 4) is provided to penetrate through the elastic tube 150 to reach the second through hole H2 (shown in FIG. 3 and FIG. 4).

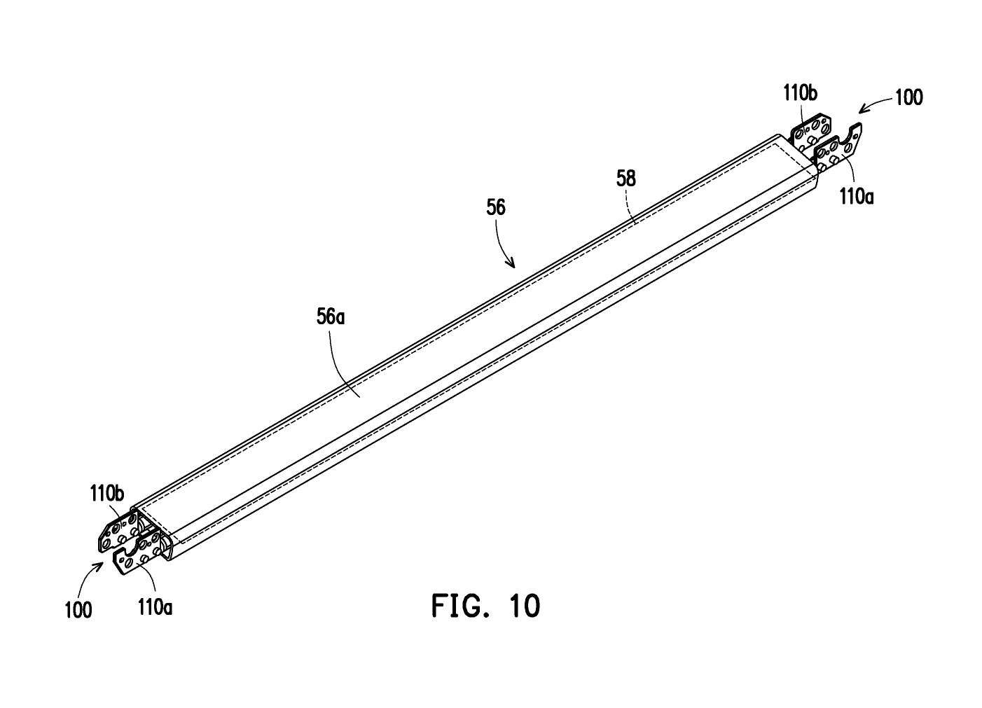

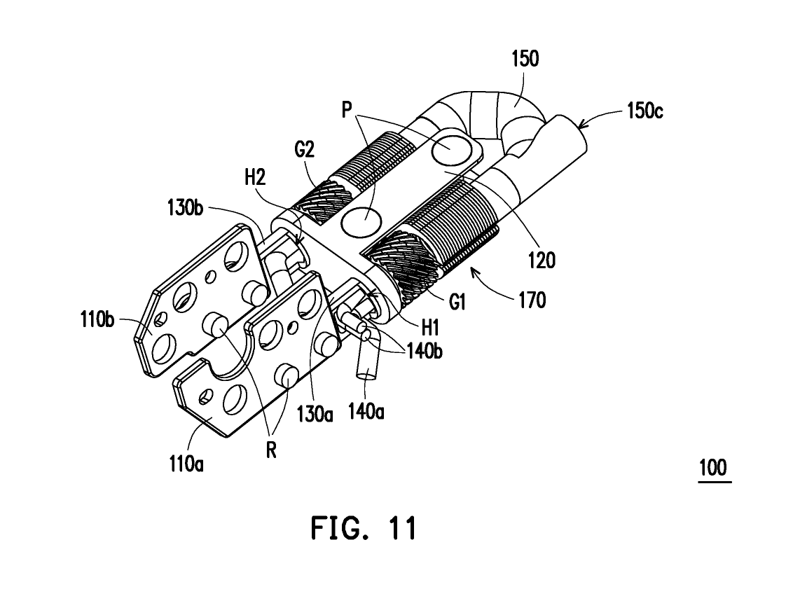

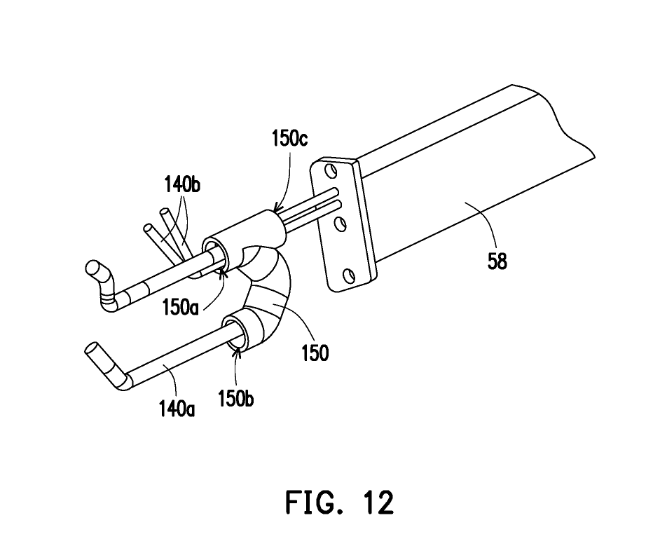

FIG. 10 is a three-dimensional view of a pivot assembly according to another embodiment of the invention. FIG. 11 is a three-dimensional view of part of components of a hinge structure of FIG. 10. FIG. 12 is a three-dimensional view of part of components of the pivot assembly of FIG. 10. A difference between the embodiment illustrated in FIG. 10 to FIG. 12 and the embodiment illustrated in FIG. 1 to FIG. 7 includes that an antenna 58 is disposed in the pivot assembly 56, and two cables 140a and 140b are included in the hinge structure 100. The configuration and operation of the cable 140a is similar to the configuration and operation of the cable 140 of FIG. 4. The elastic tube 150 further includes a third opening 150c. The cable 140b penetrates through the first through hole H1 and passes through the first opening 150a and the third opening 150c, as such, the cable 140b may be connected between the antenna 58 and the host 52 (illustrated in FIG. 1) end.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A hinge structure, comprising:
a pivot bracket;
a first shaft, pivoted to the pivot bracket and having a first through hole;
a second shaft, pivoted to the pivot bracket and having a second through hole; and
a cable, comprising a first penetrating segment, a second penetrating segment, and a curved segment, wherein the first penetrating segment penetrates through the first through hole, the second penetrating segment penetrates through the second through hole, and two ends of the curved segment are respectively connected to the first penetrating segment and the second penetrating segment.

2. The hinge structure as claimed in claim 1, wherein the first shaft is pivoted to the pivot bracket along a first axis, the second shaft is pivoted to the pivot bracket along a second axis, and the first axis is parallel to the second axis.

3. The hinge structure as claimed in claim 2, wherein the first through hole extends along the first axis, and the second through hole extends along the second axis.

4. The hinge structure as claimed in claim 1, adapted for an electronic device and comprising a first holder and a second holder, wherein the first holder is connected to the first shaft, the first shaft is adapted for being connected to a host of the electronic device through the first holder, the second holder is connected to the second shaft, and the second shaft is adapted for being connected to a display of the electronic device through the second holder.

5. The hinge structure as claimed in claim 4, wherein the pivot bracket is located between the first holder and the curved segment and is located between the second holder and the curved segment.

6. The hinge structure as claimed in claim 4, wherein the first shaft has a first groove, the second shaft has a second groove, the first groove is located between the first holder and the first through hole, the second groove is located between the second holder and the second through hole, the first penetrating segment extends to the first groove and curves in the first groove to extend to an outside of the first shaft, and the second penetrating segment extends to the second groove and curves in the second groove to extend to an outside of the second shaft.

7. The hinge structure as claimed in claim 6, wherein the first groove has a first arc-shaped surface inside, and the second groove has a second arc-shaped surface inside.

8. The hinge structure as claimed in claim 1, comprising an elastic tube, the elastic tube having a first opening and a second opening opposite to each other, the first opening and the second opening being respectively connected to the first through hole and the second through hole, the curved segment being located in the elastic tube.

9. The hinge structure as claimed in claim 8, comprising another cable, wherein the elastic tube has as third opening, and the another cable penetrates through the first through hole and passes through the first opening and the third opening.

10. An electronic device, comprising:
a host and a display; and
a hinge structure, comprising:
a pivot bracket;
a first shaft, pivoted to the pivot bracket and having a first through hole, wherein the first shaft is connected to the host;
a second shaft, pivoted to the pivot bracket and having a second through hole, wherein the second shaft is connected to the display; and
a cable, comprising a first penetrating segment, a second penetrating segment, and a curved segment, wherein the first penetrating segment penetrates through the first through hole, the second penetrating segment penetrates through the second through hole, and two ends of the curved segment are respectively connected to the first penetrating segment and the second penetrating segment.

11. The electronic device as claimed in claim 10, wherein the first shaft is pivoted to the pivot bracket along a first axis, the second shaft is pivoted to the pivot bracket along a second axis, and the first axis is parallel to the second axis.

12. The electronic device as claimed in claim 11, wherein the first through hole extends along the first axis, and the second through hole extends along the second axis.

13. The electronic device as claimed in claim 10, wherein the hinge structure comprises a first holder and a second holder, the first holder is connected to the first shaft, the first shaft is connected to the host through the first holder, the second holder is connected to the second shaft, and the second shaft is connected to the display through the second holder.

14. The electronic device as claimed in claim 13, wherein the pivot bracket is located between the first holder and the curved segment and is located between the second holder and the curved segment.

15. The electronic device as claimed in claim 13, wherein the first shaft has a first groove, the second shaft has a second groove, the first groove is located between the first holder and the first through hole, the second groove is located between the second holder and the second through hole, the first penetrating segment extends to the first groove and curves in the first groove to extend to an outside of the first shaft, and the second penetrating segment extends to the second groove and curves in the second groove to extend to an outside of the second shaft.

16. The electronic device as claimed in claim 15, wherein the first groove has a first arc-shaped surface inside, and the second groove has a second arc-shaped surface inside.

17. The electronic device as claimed in claim 10, wherein the hinge structure comprises an elastic tube, the elastic tube has a first opening and a second opening opposite to each other, the first opening and the second opening are respectively connected to the first through hole and the second through hole, and the curved segment is located in the elastic tube.

18. The electronic device as claimed in claim 17, wherein the hinge structure comprises another cable, the elastic tube has a third opening, and the another cable penetrates through the first through hole and passes through the first opening and the third opening.

19. An assembling method of a hinge structure, comprising:
pivoting a first shaft to a pivot bracket;
pivoting a second shaft to the pivot bracket;
providing a cable to penetrate through a first through hole of the first shaft;
curving the cable penetrating out through the first through hole; and
providing the curved cable to penetrate through a second through hole of the second shaft.

20. The assembling method of the hinge structure as claimed in claim 19, comprising:
connecting two ends of an elastic tube to the first through hole and the second through hole respectively;
providing the cable penetrating out through the first through hole to penetrate through the elastic tube to reach the second through hole.
